(19) United States
(12) Patent Application Publication
(10) Pub. No.: US 2007/0292162 A1
(43) Pub. Date: Dec. 20, 2007

(54) Systems, methods, and compositions for reducing ink foam

(76) Inventors: Keren Regev, Rehovot (IL); Yael Warman, Rehovot (IL); Oren Wilde, Rehovot (IL); Albert Teishev, Rehovot (IL); Yavin Atzmon, Rehovot (IL); Boaz Tagansky, Rehovot (IL); Amiran Lavon, Rehovot (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/454,684

(22) Filed: Jun. 15, 2006

(51) Int. Cl. G03G 15/10; G03G 15/02

(52) U.S. Cl. 399/237

(57) ABSTRACT

A method for reducing foam associated with an ink reservoir of a printing press is provided. The method can include printing a plurality of printed images with a nonaqueous ink delivered from an ink reservoir, periodically delivering a defoaming agent into the ink reservoir to reduce foam formation in the ink reservoir, and periodically delivering a charge control agent into the ink reservoir to charge the nonaqueous ink. Accordingly, fresh defoaming agent can be added to the ink reservoir periodically to reduce the level of foam in the reservoir and thus avoiding increasing foam levels associated with the degradation of the defoaming agent over time.

### FIELD OF THE INVENTION

The present invention relates generally to improving the functionality of printing presses. More particularly, the present invention relates to the reduction of ink foam in the ink reservoirs of such printers.

### BACKGROUND OF THE INVENTION

Many large printing presses have printing issues that arise that do not typically occur in many smaller format printers. Liquid electrophotographic printers (LEP), for example, spray ink through an electric field onto a charged drum to form a pattern. These very high volume printers require large volumes of ink in associated ink tanks or reservoirs. Foam is generated within the ink reservoirs over time as the ink is replenished during the printing process. Though foam may form for a variety of reasons, in some cases, the adding of silicon oil additives to nonaqueous inks may increase the rate of foaming.

Numerous problems may be caused by the presence of foam in the ink reservoirs. For example, foam may cause print quality reduction through the introduction of bubbles and scratches in printed images. Additionally, significant amounts of foam may collect and overflow, thus increasing the likelihood of contamination between ink reservoirs.

Various attempts to rectify this problem have been attempted. For example, inks have been formulated to include defoaming agents. Defoaming agents have a tendency, however, to degrade in the ink tank and in ink filters. Accordingly, such a formulation does not provide a long-term solution to foaming. In other examples, high amounts of defoaming agent have been added to the ink in order to compensate for the degradation of the agent. This solution has little or no effect on foam height in the ink tank, however.

As such, it would be beneficial to provide a method for decreasing foam generation in the ink reservoirs of such printers to reduce the likelihood of contamination and to improve the quality of printing.

### BRIEF DESCRIPTION OF THE DRAWINGS

FIG. 1 is a schematic representation of a portion of a printing system in accordance with an embodiment of the present invention; and

FIG. 2 is a schematic representation of a portion of a printing system in accordance with another embodiment of the present invention.

### DETAILED DESCRIPTION OF THE PREFERRED EMBODIMENT(S)

Before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

In describing and claiming the present invention, the following terminology will be used.

The singular forms “a,” “an,” and “the” include plural referents unless the context clearly dictates otherwise. Thus, for example, reference to “an ink” includes reference to one or more of such inks.

The term “printing press” refers to any printer utilizing a process whereby an image is printed on a first surface, such as a drum, and subsequently transferred to a print substrate.

As used herein, “electrophotographic” processes refer to dry or liquid electrophotography processes used in creating an electrostatic latent image, then transferring particles to the latent image, and transferring the particles to a substrate. Thus, electrophotography is intended to include dry processes involving small particulates, as well as liquid processes where particulates are suspended in a liquid carrier and the process involves electrophoretic mechanisms for transferring the particles to a latent image, and then to a substrate.

The terms “liquid electrophotographic printing,” “liquid electrostatic printing” and “LEP” can be used interchangeably, and refer to a process whereby a liquid toner is printed through an electric field onto a surface to form an electrostatic pattern. In many LEP processes, this pattern is then transferred to at least one intermediate surface, and then to a substrate, although the pattern may be transferred directly to the substrate. The term “liquid electrophotographic printer” refers to a printer capable of LEP.

As used herein, the term “periodic” refers to events that occur from time to time. It should be understood that the events may occur at regular or irregular intervals. Typically, periodic events are based on time intervals or “as needed” intervals.

As used herein, the term “substantially” refers to the complete or nearly complete extent or degree of an action, characteristic, property, state, structure, item, or result. For example, an object that is substantially enclosed would mean that the object is either completely enclosed or nearly completely enclosed. The exact allowable degree of deviation from absolute completeness may in some cases depend on the specific context. However, generally speaking the nearness of completion can be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

As has been described, foam generation in the ink reservoirs of many types of printing presses can cause various printing and operational problems. Such printers are often designed to print at very high volumes; often many thousands or tens of thousands of images may be printed at a time or in a given run. Problems associated with foam in the ink reservoirs slow this process, and as such, time and money may be wasted due to often necessary frequent cleaning of the machine and the ink reservoirs. A method of reducing foam associated with an ink reservoir or tank is hereby provided that may reduce many of the described problems. As has been discussed, defoaming agent tends to degrade in the ink reservoirs and the ink filters over time. Periodically adding defoaming agent to the ink reservoirs can adequately reduce the level of foam. In one aspect, for example, a method for reducing foam associated with an ink reservoir of a printing press may include printing a plurality of printed images with a nonaqueous ink delivered from an ink reservoir, periodically delivering a defoaming agent into the ink reservoir to reduce foam formation in the ink reservoir, and periodically delivering a charge control agent into the ink reservoir to charge the nonaqueous ink. Accordingly, fresh defoaming agent can be added to the ink reservoir periodically to reduce the level of foam in the reservoir, and thus, avoid increasing foam levels associated with the degradation of the defoaming agent over time.

Various methods of periodically introducing the defoaming agent into the ink reservoir are contemplated. In one aspect, for example, defoaming agent may be manually introduced into an ink reservoir. Though this method may provide some benefit, such introduction may occur sporadically due to a dependency on human nature. Additionally, such manual introduction may require a cessation of operation of the printing press, and thus slowing a given printing operation.

In another aspect, the defoaming agent can be automatically added into the ink reservoir of the printing press to reduce the generation of foam therein. Such automatic introduction may be accomplished by a dedicated apparatus or it may be accomplished by an existing system associated with the press that periodically introduces an additional ingredient into the ink reservoir. For example, various nonaqueous printing presses periodically introduce carrier oils into the ink reservoir to suspend the colorant. In such cases, the defoaming agent may be added to an oil system, and thus, be periodically added with the oil. Though included as part of the present invention, given the volume of many oil-delivery systems, however, the defoaming agents may degrade in the oil in a similar manner to that which is added to the ink reservoir.

Another potentially useful method of automatically introducing the defoaming agent into the ink reservoir may be by means of a charging system. Various printing presses, such as LEP printers in particular, apply ink to a charged drum in order to form a pattern or image. To facilitate the printing process, the ink is given an electrical charge. This process occurs by means of a charging system that periodically introduces a charge control agent into the ink reservoir. A defoaming agent may thus be delivered from the charging system into the ink reservoir. In one aspect, the defoaming agent and the charge control agent may be delivered independently of one another. In another aspect, the two agents may be delivered in a dependent manner, for example, by concurrent delivery. In such a concurrent delivery, the defoaming agent and the charge control agent may be delivered as separate liquids, or they may be delivered as a single liquid. Such a single liquid composition is described more fully below.

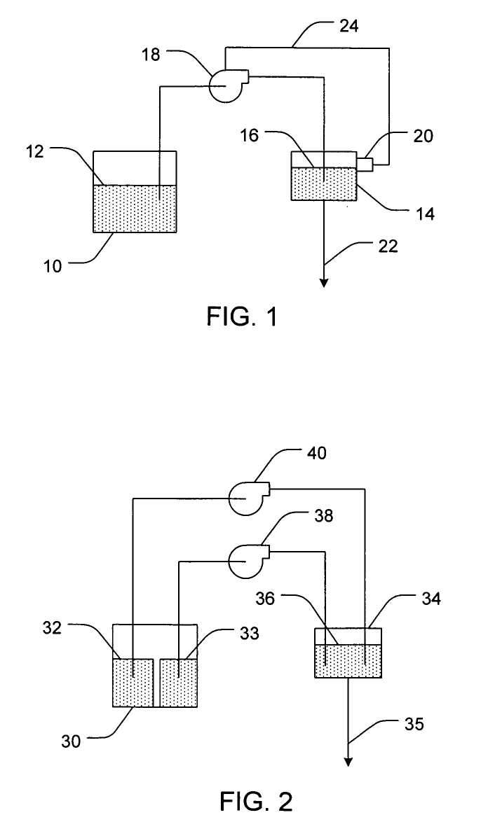

Various aspects of the present invention also provide a system for liquid electrophotographic printing. In one aspect, as shown in FIG. 1 for example, such a system may include a charging system 10 containing a charge control agent and a defoaming agent 12, and an ink reservoir 14 containing a nonaqueous ink 16, where the ink reservoir is configured to receive charge control agent and defoaming agent from the charging system. The nonaqeuous ink is removed from the ink reservoir to be printed, as shown at 22. Such a system would allow periodic introduction of fresh charge control agent and defoaming agent to the ink reservoir to reduce foam generation therein. Note that FIG. 1 shows the defoaming agent and the charge control agent as a single liquid.

Numerous means are contemplated for introducing the charge control agent and the defoaming agent 12 into the ink reservoir 14. As such, any means of moving a fluid from one reservoir to another would be included in the scope of the present invention. In many cases the means for such a movement of fluid will be dictated by the configuration of the particular press and/or charging system being utilized. In one aspect, however, the liquid containing the charge control agent and the defoaming agent may be introduced into the ink reservoir by a pump 18. Pumps and associated systems are well known to those of ordinary skill in the art, and would be readily understood and implemented. In addition to pumps, gravity feed, jetting systems, and other similar systems may also be utilized.

As has been described, the defoaming agent can be added into the ink reservoir periodically. Such a periodic introduction may be at regular or at irregular intervals. In one aspect, for example, the defoaming agent may be added following a set number of printed images. Assuming that the rate of printing is constant, addition of the defoaming agent would thus be at regular intervals. As the number of printed images increase, the likelihood of foaming in the ink reservoir may actually decrease due to the more rapid turnover of ink in the ink reservoir. In some cases, the longer the printer is in continuous operation, the greater the likelihood of foaming. As such, the defoaming agent may also be added to the ink reservoir following a set number of minutes of operation of the printer. Accordingly, both the number of printed images and the number of minutes of operation of the printer may be utilized to provide a periodic timing reference for the addition of the defoaming agent.

In another aspect, the periodic introduction of the defoaming agent may be at irregular periodic intervals. Such an irregular introduction in some cases may provide a more accurate response to the generation of foam in the ink reservoirs. For example, foam will form more quickly in the ink reservoir when printing images containing large amounts of ink than when printing images with small amounts of ink due to the differential rate at which the ink is being used. Accordingly, in one aspect, the defoaming agent may be added at an interval that is related to ink use. For example, as a set amount of ink is used, defoaming agent can be introduced into the ink reservoir via the charging system. It should be noted that, particularly with consistent printing operations, such an irregular interval may actually occur at fairly regular intervals.

In yet another aspect, the defoaming agent may be added to the ink reservoir as a result of the generation of foam in the ink reservoir. In this case, a foam level sensor 20 may be included in the ink reservoir 14 as shown in FIG. 1. By functionally coupling the foam level sensor to the charging system 10, defoaming agent 12 can be automatically added to the ink reservoir upon the sensing that foam has exceeded a predetermined foam level. FIG. 1 shows one possible nonlimiting configuration whereby the foam level sensor is functionally coupled 24 to the charging system via the pump 18. When the predetermined foam level has been exceeded, the pump may be activated in order to introduce defoaming agent into the ink reservoir.

In a further aspect, defoaming agent can be added into the ink reservoir as a result of a condition of the nonaqueous ink that may be unrelated to the level of foam in the ink reservoir. As has been described, the ink is charged by the charge control agent prior to printing in order to provide the ink with particular characteristics when printed on the drum of the printing press. As the charge of the ink in the ink reservoir decreases, additional charging fluid can be added. As such, in one aspect, a sensor for detecting the charge of the ink may be utilized to automatically maintain a particular ink-charge. Thus, the defoaming agent, particularly when mixed with the charging fluid, may be introduced periodically into the ink reservoir as a result of the decreasing charge of the ink. Though not necessarily linked to foam generation, such an introduction of defoaming agent as a result of the decreasing charge of the ink can provide a convenient method of maintaining fresh defoaming agent in the ink reservoir to thus reduce the levels of generated foam.

The defoaming agent and the charge control agent may also be included in the charging system as separate liquids. As is shown in FIG. 2, for example, such a system may include a charging system 30 containing a charge control agent 33 that is maintained separate from a defoaming agent 32. The system may also include an ink reservoir 34 containing a nonaqueous ink 36, where the ink reservoir is configured to separately receive both the charge control agent and the defoaming agent from the charging system. The nonaqeuous ink is removed from the ink reservoir to be printed, as shown at 35. Such a system would allow the periodic introduction of fresh charge control agent to charge the ink separate from the periodic introduction of fresh defoaming agent into the ink reservoir to reduce foam generation therein.

Numerous means are contemplated for introducing the charge control agent 33 and the defoaming agent 32 into the ink reservoir 34 as separate liquids. As such, any means of moving the fluids from the charging system 30 to the ink reservoir 34 would be included in the scope of the present invention. As with the previous aspect, the means for such a movement of fluids may be dictated by the configuration of the particular press and/or charging system being utilized. In one aspect, however, the charge control agent and the defoaming agent may be introduced into the ink reservoir by separate pumps, namely a charging pump 38 and a defoaming pump 40. It should be noted that it is also contemplated to utilize a single pump to deliver both agents to the ink reservoir, either individually through the use of a switching valve or simultaneously (not shown).

It is contemplated that numerous defoaming agents may be utilized according to various aspects of the present invention to reduce foaming in an ink reservoir. Accordingly, any chemical that may be periodically introduced into an ink reservoir of a printing press to reduce foam may be considered to be within the scope of the present invention. In one aspect, for example, and without limitation, the defoaming agent may include siloxanes, alkylated siloxanes, dimethicones, polymers thereof, and combinations thereof. In various aspects, the defoaming agent may be an alkylated siloxane such as a methylsiloxane, a dimethysiloxane, etc. In one specific aspect, the defoaming agent may be a cyclopentasiloxane. In another aspect, the defoaming agent may be a polysiloxane. In yet another aspect, the defoaming agent may be a dimethicone. One useful dimethicone may include a dimethicone/dimethicone vinyl cross polymer. In a further aspect, the defoaming agent may be a combination of dimethicone/dimethicone vinyl cross polymer and cyclopentasiloxane.

It is also contemplated that various charge control agents may be utilized according to various aspects of the present invention for association with the defoaming agent. Accordingly, any chemical that may be periodically introduced into an ink reservoir of a printing press to charge or control charge of the ink may be considered to be within the scope of the present invention. In one nonlimiting aspect, for example, the charge control agent may include lecithin, polyaniline, calcium petronate, sodium petronate, barium petronate, (petronates are aryl alkyl sulfonates available from Chemtura Corporation of Middlebury, Conn.), succinimide, dioctyl sodium sulfosuccinate, dodecylamine, ACRYLOID 917, OLOA 1200, or combinations thereof. In another aspect, the charge control agent can include at least three ingredients selected from lecithin, polyaniline, calcium petronate, sodium petronate, barium petronate, succinimide, dioctyl sodium sulfosuccinate, dodecylamine. In yet another aspect, the charge control agent can include at least lecithin, barium petronate, and succinimide.

A liquid vehicle used to carry the charge control agent and/or the defoaming agent is typically present, and may include a variety of different components depending on the nature of the charging agent, defoaming agent, ink, and/or the specific printing process. The liquid vehicle may thus include any liquid composition that can be used to carry the charging agent/defoaming agent, including any other added components. Liquid vehicles are well known in the art, and a wide variety of liquid vehicles can be used in accordance with embodiments of the present invention. Such liquid vehicles can include a mixture of a variety of different additives, including without limitation, solvents, co-solvents, buffers, biocides, etc. Though a variety of additives can be used, the liquid vehicle, in some embodiments, can be simply a single liquid component, such as water or an oil.

Various aspects of the present invention also provide a composition for charging and reducing foaming in nonaqueous inks. Such a composition may include a liquid vehicle, a charging agent, and a defoaming agent. Amounts of the various ingredients may vary depending on the particular formulation and intended use of the composition. In one aspect, however, the defoaming agent can be present in an amount of from about 0.01 w % to about 0.5 w %. In another aspect, the defoaming agent can be present in an amount of from about 0.04 w % to about 0.1 w %. Additionally, in one aspect the charge control agent can be present in the composition in an amount of from about 5.0 w % to about 40.0 w %. In another aspect, the charge control agent can be present in an amount of from about 10.0 w % to about 30.0 w %.

### EXAMPLES

### Example 1

An ink formulation can be prepared as follows: 750 grams of polyethylene-acrylic acid co-polymer (NUCREL 699 DUPONT) is mixed in a double planetary mixer with 1750 grams of an ISOPAR L (iso-paraffinic oil; EXXON) carrier liquid at 60 rpm and at 130° C. for one hour. The temperature is reduced and mixing is continued until the mixture reaches room temperature. 1500 grams of the mixture is charged into a Union Process 1S ball atritor together with 10 grams of aluminum tri-stearate as a charge adjuvant, 65 grams of pigment blue 15:3 pigment (Toyo Ink), and 700 grams of additional ISOPAR L. 10 grams of silica may optionally be added. The mixture is ground for 2 hours at 55° C. followed by grinding for 10 hours at 40° C. until a toner concentrate having toner particles incorporating the adjuvant and the pigment is produced.

### Example 2

A composition of a charge control agent and a defoaming agent can be prepared as follows: A charge control agent solution is produced by mixing 30.0 w % lecithin, 40.0 w % barium petronate, and 29.0 w % of ZONYL 3300B. To this solution, 0.1 w % of dimethicone/dimethicone vinyl cross polymer and 0.9 w % of cyclopentasiloxane is added. The resulting solution may be periodically added to the ink in an ink reservoir to reduce foaming therein.

### Example 3

Cyan, magenta, yellow, and black ink formulations that are often used to print from an LEP device were monitored for foam height within their respective ink tanks over several thousand impressions. The foam height for each of the inks in the period from 4500 to 4650 impressions ranged from between 60 and 85 mm for each of the inks. About 2 ml of the solution of Example 2 was introduced into each of the respective ink reservoirs at between 4650 and 4700 impressions. Following this addition of the defoaming agent, the level of foam in the ink reservoirs was reduced. More specifically, the foam present in the respective inks after from 30 to 100 impressions following addition of defoaming agent/charge control agent was reduced by from about 15% to about 70%.

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A system for liquid electrophotographic printing, comprising:
a charging system containing a charge control agent and a defoaming agent;
an ink reservoir containing a nonaqueous ink, the ink reservoir configured to receive charge control agent and defoaming agent from the charging system.

2. The system of claim 1, wherein the charge control agent and the defoaming agent are contained within the charging system as a single liquid.

3. The system of claim 1, wherein the charge control agent includes at least one member selected from the group consisting of lecithin, polyaniline, alkyl aryl sulfonates, succinimide, dioctyl sodium sulfosuccinate, dodecylamine, and combinations thereof.

4. The system of claim 3, wherein alkyl aryl sulfonates are selected from the group consisting of calcium petronate, sodium petronate, barium petronate and combinations thereof.

5. The system of claim 3, wherein the charge control agent includes at least three members selected from the group consisting of lecithin, polyaniline, alkyl aryl sulfonates, succinimide, dioctyl sodium sulfosuccinate, dodecylamine, and combinations thereof.

6. The system of claim 5, wherein alkyl aryl sulfonates are selected from the group consisting of calcium petronate, sodium petronate, barium petronate and combinations thereof.

7. The system of claim 6, wherein the charge control agent includes lecithin, barium petronate, and sulfosuccinate.

8. The system of claim 1, wherein the defoaming agent includes a member selected from the group consisting of siloxanes, alkylated siloxanes, dimethicones, polymers thereof, and combinations thereof.

9. The system of claim 8, wherein the defoaming agent is an alkylated siloxane, said alkylated siloxane being a methylsiloxane.

10. The system of claim 8, wherein the siloxane is a polysiloxane.

11. The system of claim 8, wherein the defoaming agent is a dimethicone.

12. The system of claim 9, wherein the defoaming agent is a dimethicone/dimethicone vinyl cross polymer.

13. The system of claim 1, wherein the defoaming agent is a cyclopentasiloxane.

14. The system of claim 13, wherein the defoaming agent is a combination of dimethicone/dimethicone vinyl cross polymer and a cyclopentasiloxane.

15. The system of claim 1, further comprising a foam level sensor functionally coupled to the ink reservoir and to the charging system.

16. A method for reducing foam associated with an ink reservoir of a printing press, comprising:
printing a plurality of printed images with a nonaqueous ink, the nonaqueous ink being delivered from an ink reservoir;
periodically delivering a defoaming agent into the ink reservoir to reduce foam formation in the ink reservoir; and
periodically delivering a charge control agent into the ink reservoir to charge the nonaqueous ink.

17. The method of claim 16, wherein the printing press is a liquid electrophotographic printer.

18. The method of claim 16, wherein the defoaming agent and the charge control agent are delivered concurrently.

19. The method of claim 18, wherein the defoaming agent and the charge control agent are delivered as a single liquid.

20. The method of claim 16, further comprising:
sensing that foam in the ink reservoir has exceeded a predetermined foam level; and
delivering defoaming agent into the ink reservoir as a result of the sensing.

21. A composition for charging and reducing foaming of a nonaqueous ink, comprising a liquid vehicle, a charging agent, and a defoaming agent.

22. The composition of claim 21, wherein the defoaming agent includes a member selected from the group consisting of siloxanes, alkylated siloxanes, dimethicones, polymers thereof, and combinations thereof.

23. The composition of claim 22, wherein the defoaming agent is a dimethicone/dimethicone vinyl cross polymer.

24. The composition of claim 22, wherein the charge control agent includes at least three members selected from the group consisting of lecithin, polyaniline, aryl alkyl sulfonates, succinimide, dioctyl sodium sulfosuccinate, dodecylamine, and combinations thereof.

25. The composition of claim 24, wherein aryl alkyl sulfonates are selected from the group consisting of calcium petronate, sodium petronate, barium petronate, and combinations thereof.

26. The composition of claim 22, wherein the defoaming agent is present in an amount of from about 0.01 w % to about 0.5 w %.

27. The composition of claim 22, wherein the defoaming agent is present in an amount of from about 0.04 w % to about 0.1 w %.

28. The composition of claim 22, wherein the charge control agent is present in an amount of from about 5.0 w % to about 40.0 w %.

29. The composition of claim 22, wherein the charge control agent is present in an amount of from about 10.0 w % to about 30.0 w %.
